(19) United States
(12) Patent Application Publication
(10) Pub. No.: US 2008/0040468 A1
(43) Pub. Date: Feb. 14, 2008

(54) Remote screen sharing based support of consumer appliances

(76) Inventors: John Mao, San Jose, CA (US); Larry Dorie, Los Altos, CA (US)

Correspondence Address: FOOTHILL LAW GROUP, 777 N. FIRST STREET, SUITE 325, SAN JOSE, CA, 95112, US

(21) Appl. No.: 11/504,296

(22) Filed: Aug. 14, 2006

(51) Int. Cl. G06F 15/173

(52) U.S. Cl. 709/223

(57) ABSTRACT

A method for facilitating remote support of an appliance is disclosed. A controlled client installed in an appliance is connected via a server to the controlling client installed in a remote computer. Upon proper initiation the controlled appliance display is shown on the controlling client. The controlling client is able to see and affect the necessary support at the controlled client.

### BACKGROUND OF THE INVENTION

1. Field of the Invention

The present invention relates to a method of remotely controlling a device over Internet and more particularly to remotely controlling a device such as a television, cellular telephone or any device having a video output.

2. Description of Prior Art

Web conferencing user (host) at a local computer initiates meeting conference at the web conferencing server. The host invites a user (attendee) at the remote computer to join a meeting by telling the attendee the web conferencing server address, meeting ID and password. Before the host and attendee can host/join a meeting, they must download a client software component from the server. After the download and installation, both client software modules connect to the server with the meeting ID and password for authentication purpose, which in turn links two computers (Local Computer and Remote Computer) together by routing data packets from one client to the other.

### SUMMARY OF THE INVENTION

It is an object of the present invention to provide a method to remotely access from a remote computer a device equipped with a video display, capture the image on the screen as a user sees it, and assist with resolving the problems the user is experiencing.

Another object of the present invention is to capture the remote control device the user is using to operate the device equipped with video display and operate it from the remote computer.

Briefly, web conferencing technology is adopted by means of a software module implanted in device to be controlled so that it can be accessed by the remote computer that also has an adopted web conferencing software module implanted therein. A server is positioned to transmit information between the controlled device and the controlling device. The controlled device sends the information to the controlling device. The remote computer captures the image on the screen of the controlled device and issues the commands necessary to remedy the problems the user is experiencing.

These and other objects and advantages of the present invention will become obvious to those with ordinary skill in the art after having studied the following description, drawings and the claims.

It is understood that while the drawings and the following discussion relate to a particular embodiment of the present invention, this embodiment merely represents what is presently regarded as the best mode of practicing the invention and other modifications may be made to the particular embodiment without departing from the spirit and scope of the invention.

### BRIEF DESCRIPTION OF THE DRAWINGS

FIG. 1 shows the general architecture of the invention

FIG. 2 diagrams the basic data flow

FIG. 3 and FIG. 3a. shows an example of the display on the appliance

FIG. 4 shows the registration process

FIG. 5 is a flow diagram of a typical support session.

### DETAILED DESCRIPTION

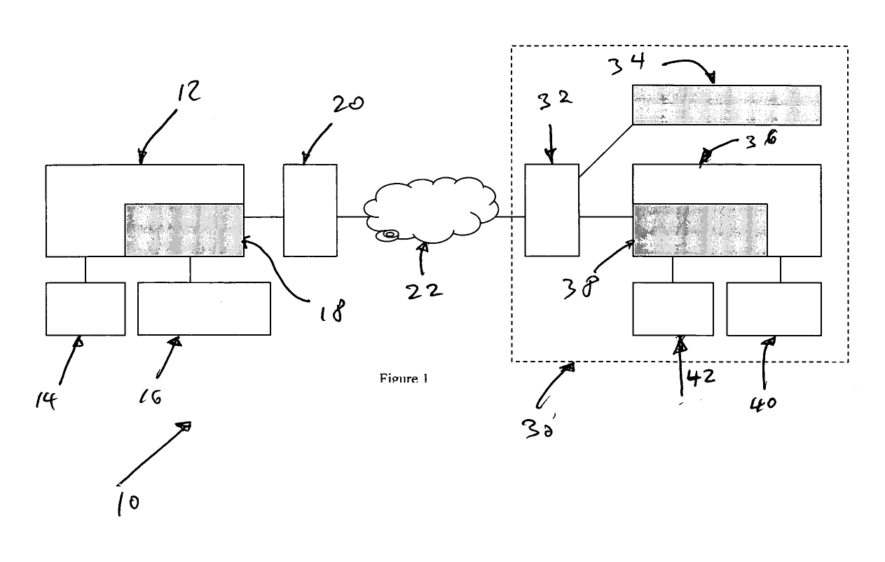

Referring to FIG. 1, the architecture 10 of a typical system is shown. Included are the controlled appliance 12 having a video display 14, a controller 16 in the form of a keyboard, a mouse, digital writing system or a remote device and the controlled client software 18 installed in controlled appliance 12. A person skilled in the art will be able to determine the type of software suitable for this application. Coupled to the controlled appliance 12 is any suitable firewall configuration 20. Via the network 22, which may typically be TCP/IP (Transmission Control Protocol/Internet Protocol) or any other suitable network, the controlled appliance 12 is connected to the support service organization 30. Included in the support service organization are a firewall 32, support server 34, remote support computer 36, a video display 42, a controller 40 in the form of a keyboard, a mouse, digital writing system or a remote device and the controlling client software 38 installed in the support computer 36. A person skilled in the art will be able to determine the type of software suitable for this application.

In a typical embodiment the controlled client software 18 captures the data to be displayed on display 14 or another display unit and transmits it via the support server 34 to the controlling client 38 to display at remote support computer 36 video display 42. Since the connections between the support server 34 and the controlled client software 18 and the controlling client software 38 are outbound, the issue of firewall traversal does not arise. An inbound port in the TCP or other network employed needs to be opened to accept incoming connections from the controlled client software 18 and the controlling client software 38. Similarly, user accounts need to be created in the server to allow the controlling client software 38 to communicate with the server 34.

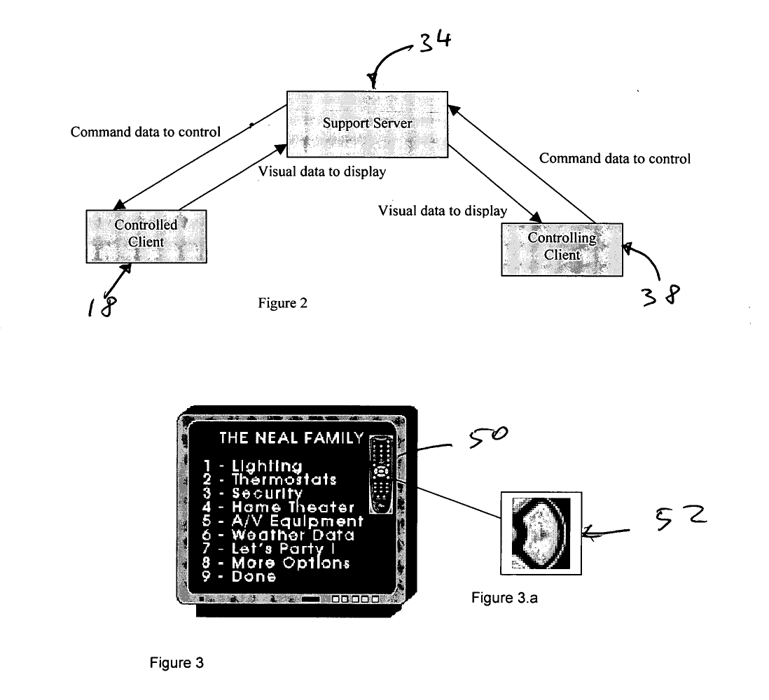

The Internet address and the listening ports of the support server 34 need to be made known to the controlled client software 18 and the controlling client software 38. Controlled client software 18 will subsequently receive the commands from the controlling client software 38 installed in the remote support computer 36. The controlling client software 38 similarly receives the data from the controlled client software 18 and displays it on the display 42 of the remote support computer 36. The controlling client software 38 also takes inputs from the controller 40 and transmits them to controlled client software 38 to control the appliance 12. The flow chart showing the information flow from the controlled client software 18 to the controlling client software 38 via the support server 34 is shown in FIG. 2. The method described herein may be used in controlling television sets, cellular telephones and other appliances with video outputs.

In another embodiment illustrated in FIG. 3 and FIG. 3a the remote support computer also displays the remote controller used to control the appliance 12. This further enables remote operation of the appliance 12. Clicking on the right key of the remote controller would cause the display as shown in FIG. 3a and enable the controlling client software 38 to detect that action, generate the appropriate command and send it to the controlled client software 18 which in turn applies this command to the controlled appliance 12.

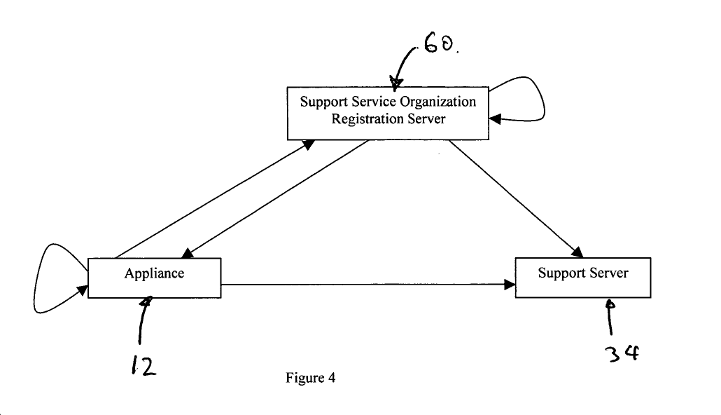

Once the controlled client software 18 is installed in appliance 12 the registration process may begin in order for appliance 12 to acquire the support server 34 Internet address and become an authorized appliance 12 at the support server 34. In the embodiment shown in FIG. 4, the appliance 12 submits a registration request tailored to suit individual application, but it typically includes a serial number, a user determined activation code and other information as desired. As the first step, the support server may be required to authenticate a controlled client software 18 before proceeding with the support operation. Upon successful authentication, the registration server 60 informs the support server 34 of the new account with the account identification information and appliance 12 serial number and also supplies to the appliance 12 the account identification information. The registration information is then saved at the appliance 12 and subsequent connections with the support server 34 may now be made. In order to connect to the support server 34 the appliance 12 sends the identification information to the support server 34. Upon verification the appliance 12 connects to the support server 34 in one of the two ways:
1. Persistent connection. In this embodiment the appliance 12 is connected to support server 34 so that the support can be obtained without an attendant being present at appliance 12. This may be useful in cases where specific activity needs to be affected on a regular schedule.
2. On-demand connection. In this embodiment the appliance 12 is connected to the support server 34 only upon making a specific request.

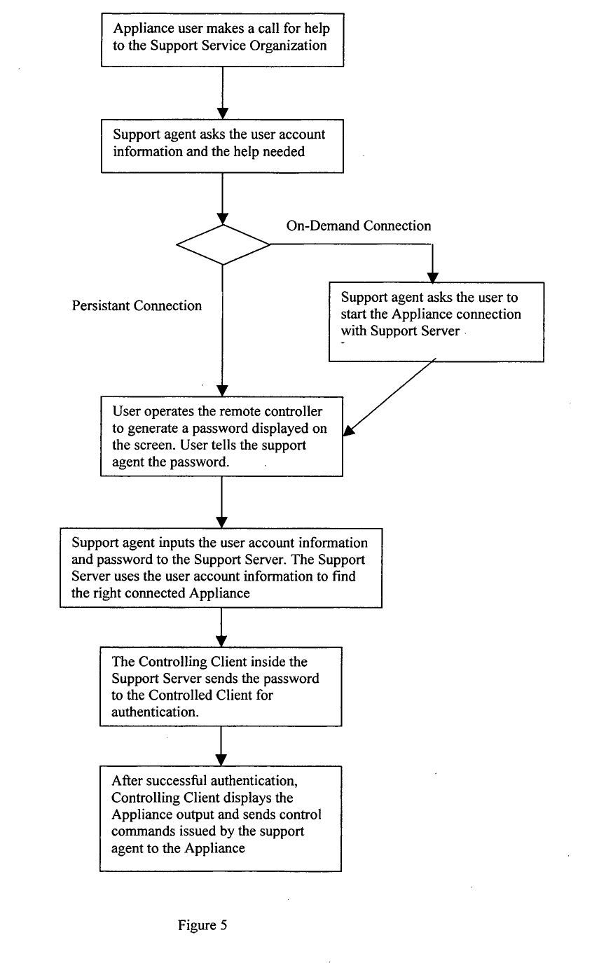

Once the connection has been made a support session may begin. Typical sequence is shown in FIG. 5. After the support session has been provided the support agent may close the support session. For greater security, the appliance 12 user may elect to close the support session.

The invention claimed is:

1. An apparatus for remotely controlling at least one appliance, said apparatus comprising:
at least one appliance coupled to a video display;
a controlled client protocol installed in said at least one appliance;
an network coupled to said at least one appliance;
a support server coupled to said network;
a remote computer with a video display coupled to said network and to said support server;
a controlling client protocol installed in said remote computer.

2. An apparatus for controlling at least one appliance employing a remote control computer, said apparatus comprising:
means for initiating a remote controlling sequence;
means for registering said at least one appliance at the support server;
means for communicating the registration results to said at least one appliance;
means for authenticating the identity of at least one appliance; and
means for initiating controlling sequence from the remote computer.

3. A method for remotely controlling at least one appliance equipped with video display from a remote computer, comprising:
installing controlled client protocol in said at least one appliance;
installing controlling client protocol in said remote computer;
providing an internet connection between a remote control computer and said at least one appliance;
requesting registration of the at least one appliance at a support server;
authenticating the registration of at least one appliance at the support server, establishing connection of at least one appliance with the support server;
starting a support session with the remote computer;
completing the support session; and
affecting termination the support session.

4. The method of claim 3, wherein said connection is a persistent connection.

5. The method of claim 3, wherein said connection is an on-demand connection.

6. The method of claim 3, wherein said termination is affected by the controlled appliance.

7. The apparatus of claim 1 further comprising a remote controller coupled to said appliance.

8. The apparatus of claim 1 wherein said controlling client protocol and said controlled client protocol are installed in the same appliance.

9. The apparatus of claim 1 wherein said network is Internet.
